(19) United States
(12) Patent Application Publication
(10) Pub. No.: US 2007/0199608 A1
(43) Pub. Date: Aug. 30, 2007

(54) Dual-Layer Chemically-Inert Tubing and Machine

(75) Inventor: Santos Anthony Puente, Poulsbo, WA (US)

Correspondence Address: CRAIN, CATON & JAMES, FIVE HOUSTON CENTER, 1401 MCKINNEY, 17TH FLOOR, HOUSTON, TX, 77010, US

(73) Assignee: VICI Metronics, Inc., Poulsbo, WA (US)

(21) Appl. No.: 11/680,472

(22) Filed: Feb. 28, 2007

Related U.S. Application Data
(60) Provisional application No. 60/767,050, filed on Feb. 28, 2006.

(51) Int. Cl. F16L 11/00

(52) U.S. Cl. 138/137; 138/114; 138/141

(57) ABSTRACT

The invention is a first colorless and chemically-inert tubing concentrically adhered to an outer colored and chemically-inert tubing such that the inner tubing remains entirely chemically inert while the jacket tubing provides color coding as to first colorless tubing inner diameter. A co-extruder to concurrently and concentrically produce a first colorless and chemically-inert tubing concentric and a colored and chemically-inert jacket tubing such that the two tubings are adhered together at the instant of production is also provided.

### CROSS REFERENCE TO RELATED APPLICATIONS

This application claims the benefit of U.S. Provisional Patent Application No. 60/498,821 entitled, “Dual Layer Chemically Inert Tubing and Machine” filed on Feb. 28, 2006 in the United States Patent and Trademark Office.

### STATEMENT REGARDING FEDERALLY SPONSORED RESEARCH OR DEVELOPMENT

Not Applicable.

### FIELD OF THE INVENTION

The present invention relates to color-coded chemically inert tubing used in conjunction with test equipment for chemical analysis of samples and to a machine for producing same.

### BACKGROUND OF THE INVENTION

It is desirable to use chemically-inert tubing in conjunction with equipment for determining the chemical composition of any analyte. Chemically inert tubing includes a number of materials, but is often polyetheretherketone. As is well known in the art, polyetheretheketone is inherently pure and has excellent mechanical properties. As connections and equipment inlets vary, tubing is often coded by color to identify its inner diameter. Typical color coding is as follows: 0.002″—Pink, 0.005″—Red, 0.007″—Yellow, 0.010″ —Blue, 0.020″—Orange, 0.030″—Green, 0.040″—Gray, and 0.055″—Black.

Such color coding however has the potential to create difficulties and is not fully accepted. While color concentrate produced from polyetheretheketone may be used for ease of identification and does not compromise its mechanical properties, the assurance of purity is questionable. The very chemicals, i.e. dye, used for color coding may not be entirely chemically-inert or may not remain entirely adhered to the tubing, thus potentially contaminating the analyte passing therethrough and causing incorrect results as to chemical composition. Some polyetheretheketone tube applications specify the use of natural polyetheretheketone tubes to assure purity of the inner structure or analyte flow path.

Encasing the chemically-inert first tubing in a jacket of a second, colored tubing would therefore be advantageous to ease identification of tubing diameter while maintaining a pure polyetheretheketone flow path for the analyte. However, if the jacketing tubing is of a material with different chemical or physical properties from the first tubing, the dual-layer tubing may not perform properly. It is therefore desirable for the jacketing tubing to be of the same chemically-inert material as the tubing. Likewise it is important that the jacketing tubing be adhered to the first tubing along its entire length to permit the dual-layer tubing to be cut to any length.

### SUMMARY OF THE INVENTION

The present invention overcomes the foregoing drawbacks of chemically inert tubing and includes a machine for production of the new product.

In one aspect of the invention a first colorless and chemically-inert tubing is concentrically adhered due to concurrent extrusion with an outer colored and chemically-inert tubing, having physical properties the same or similar to the inner tubing, such that the inner tubing remains entirely chemically inert while the jacket tubing provides color coding and so the combined tubing may be used without concern for physical property differences.

In another aspect of the invention a co-extruder is disclosed to concurrently and concentrically produce a first colorless and chemically-inert tubing concentric and a colored and chemically-inert jacket tubing such that the two tubings are adhered together at the instant of production. Tube extruders are well known in the art and the improvement depicted herein may be applied to various models. The invention depicted may be applied as an improvement to existing models or may be incorporated into new models.

The foregoing and other objectives, features, and advantages of the invention will be more readily understood upon consideration of the following detailed description of the invention, taken in conjunction with the accompanying drawings.

### BRIEF DESCRIPTION OF THE DRAWINGS

So that the manner in which the described features, advantages and objects of the invention, as well as others which will become apparent, are attained and can be understood in detail, more particular description of the invention briefly summarized above may be had by reference to the embodiments thereof that are illustrated in the drawings, which drawings form a part of this specification. It is to be noted, however, that the appended drawings illustrate only typical preferred embodiments of the invention and are therefore not to be considered limiting of its scope as the invention may admit to other equally effective embodiments.

FIG. 1 is an isometric view of the tubing disclosed herein.

FIG. 2 is a schematic of the extruder system disclosed herein.

FIG. 3 is a view of the retainer nut having thermocouple ports therein.

FIG. 4 is an isometric view of the secondary head cartridge of the present invention.

FIG. 5 is an isometric view of the flow sleeve of the secondary head cartridge.

FIG. 6 is an isometric view of the die holder of the flow sleeve.

FIG. 7 is an isometric view of the die holder inserted into the flow sleeve.

FIG. 8 depicts the ball valve.

FIG. 9 depicts the second-extruder flange adapter.

FIG. 10 depicts the ball valve seated within second-extruder flange adapter.

### DETAILED DESCRIPTION OF THE PREFERRED EMBODIMENT

The invention may be further understood by the following non-limiting examples. Although the description herein contains many specificities, these should not be construed as limiting the scope of the invention but as merely providing illustrations of some of the presently preferred embodiments of the invention. For example, thus the scope of the invention should be determined by the appended claims and their equivalents, rather than by the examples given. In general the terms and phrases used herein have their art-recognized meaning, which can be found by reference to standard texts, journal references and contexts known to those skilled in the art. The following definitions are provided to clarify their specific use in the context of the invention. All references cited herein are hereby incorporated by reference to the extent not inconsistent with the disclosure herewith.

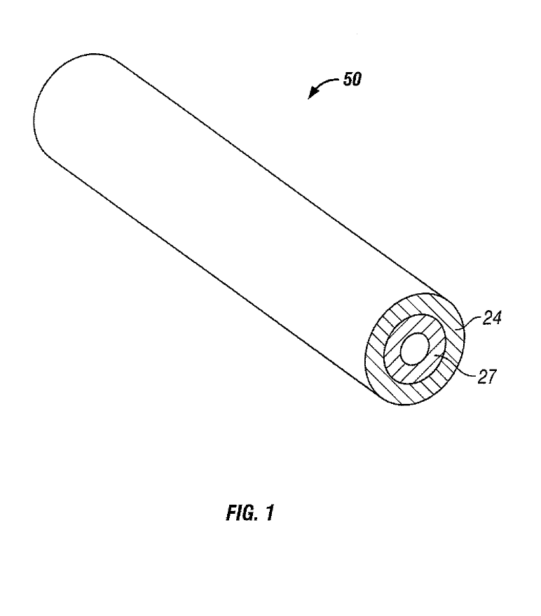

The dual layer tubing 50 of the present invention is disclosed in FIG. 1, and includes a first tubing 27 surrounded by a jacket, or second, tubing 29. Tubing jacket 29 is formed at or proximate in time to the extrusion of first tubing 27. In the preferred embodiment, first tubing 27 is composed entirely of a chemically-inert material. Ideally the chemically-inert material is colorless after production. In the preferred embodiment, jacket tubing 29 is composed of a chemically-inert material and of the same material as first tubing 27. Use of a chemically-inert material is desirable for jacket tubing 29 to preclude contamination of any analyte passing through first tubing 27. While dual layer tubing 50 should be cut normal to its length, it is foreseeable that any end may not be normal and may, particularly after insertion into a fitting, expose jacket tubing 29 to materials passing through dual layer tubing 100. Use of the same or nearly identical chemically-inert material for both first tubing 27 and jacket tubing 29 is desirable to ensure that the layers of material have near-identical chemical and physical properties, including response to temperature and atmospheric conditions, such as coefficients of expansion. In the preferred embodiment first tubing 27 and jacket tubing 29 are adhered together to ensure the dual layer tubing 50 may be reduced in length at any time without separation of first tubing 27 and jacket tubing 29. It is also desirable to avoid any joinder of first tubing 27 and jacket tubing 29 which relies predominantly on constriction as this may reduced the inner diameter of the dual layer tubing, thus altering the flow rate therethrough.

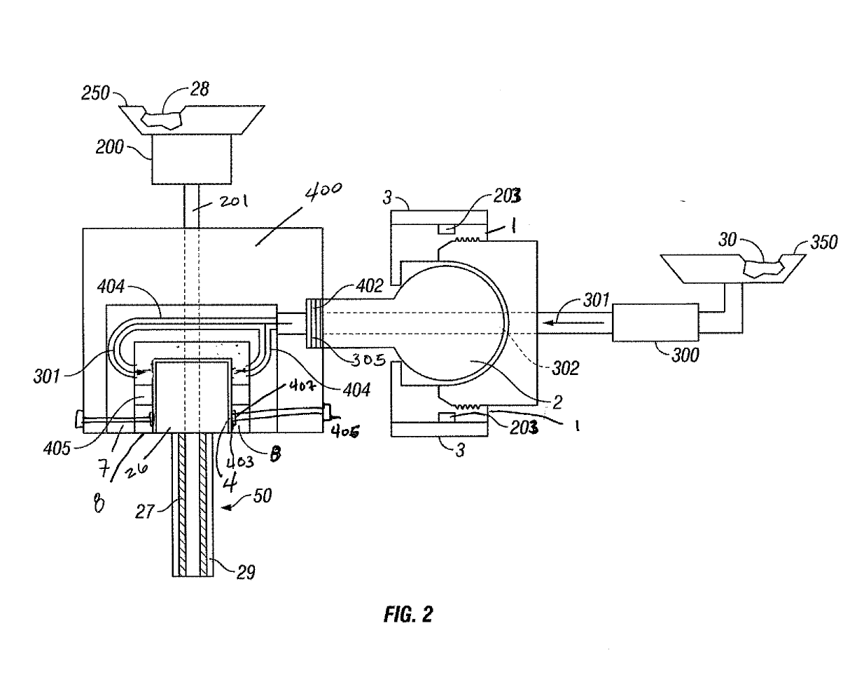

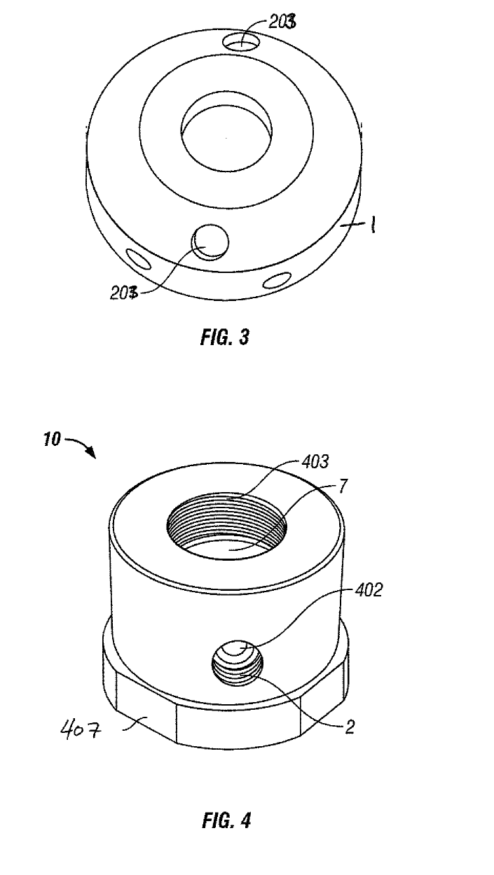

Referring to FIG. 2, the tubing extrusion system 100 includes uncolored material 28 for first tubing 27 in a first hopper 250. In the preferred embodiment, uncolored material 28 is virgin polyetheretheketone 381-G. The tubing extrusion system 100 also includes colored material 30 for jacket tubing 29 in a second hopper 350. In the preferred embodiment colored material is produced from a combination of color concentrate polyetheretheketone 381-G and virgin polyetheretheketone 381-G at a ration of approximately 1:20, respectively.

First extruder 200 and second extruder 300 operate simultaneously. Tubing extrusion system 100 includes a first extruder 200, generating a melt first stream 201 associated with uncolored material 28, a second extruder 300 generating a second melt stream 301 associated with colored material 30, and a cross head 400, which communicates with both first extruder 200 and second extruder 300.

First extruder 200 generates first melt stream composed of uncolored material 28. Within cross head assembly 400, first melt stream 201 is formed into tubing 27. Cross head assembly 400 includes a secondary head cartridge 10.

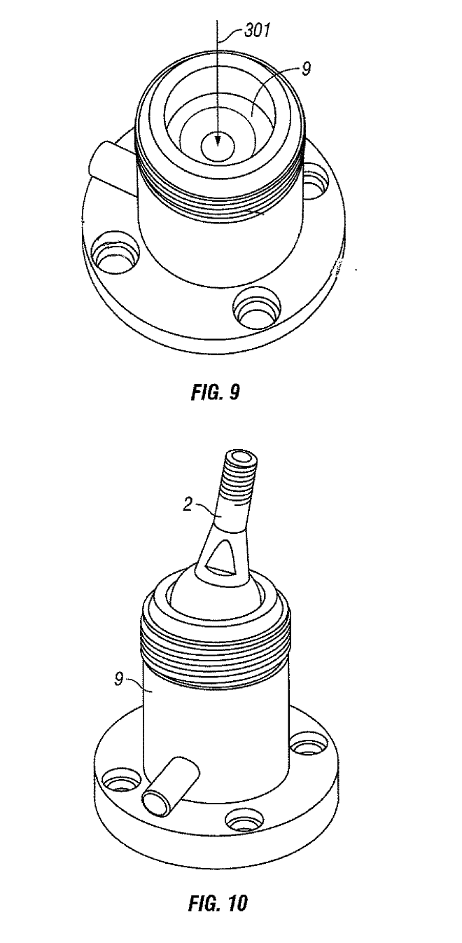

Second extruder 300 generates melt stream 301 which enters cross head 400 via ball valve 2, depicted in FIG. 8. An orifice 302 is located at one end of ball valve 2 and passes longitudinally through ball valve 2. Flange adaptor 9, depicted in FIG. 9, provides the seat for ball valve 2, as depicted in FIG. 10. Ball valve 2 terminates in a connector 305. Ball valve 2 is retained in flange adapter 9 by a retaining nut 1, which connects to flange adapter 9 and has an inner orifice with a diameter less than the cross-sectional diameter of ball valve 2.

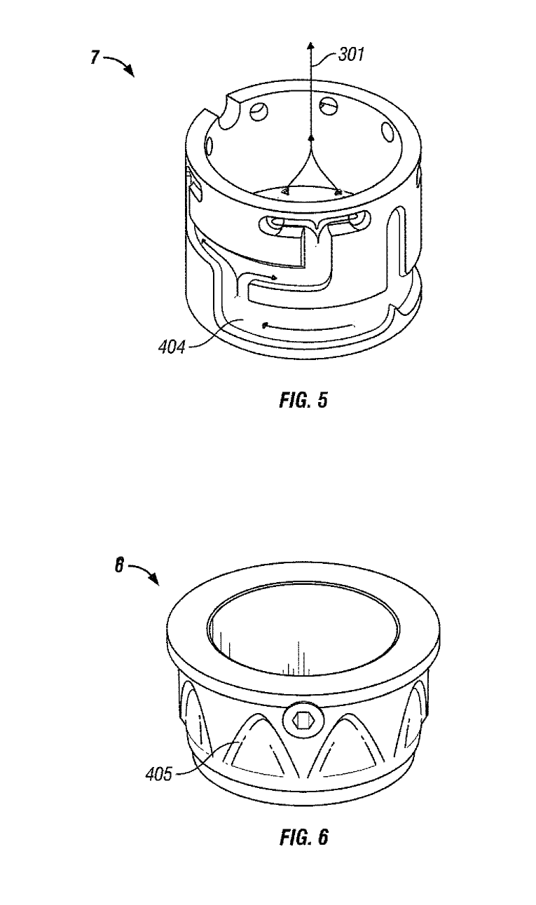

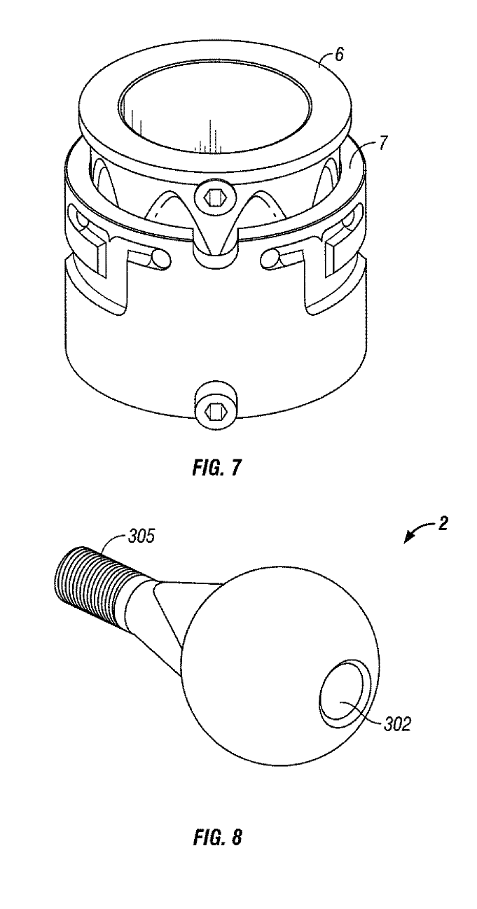

Cross head cartridge 10 is mounted to the tubing output of first extruder 200 and applies the jacket tubing 29. As depicted in FIG. 4, cross head cartridge 10 retains a flow sleeve 7. Cross head cartridge 10 includes an orifice 402 for insertion of a ball valve assembly 2, a connector 403 for a die adjuster 4, and a face 407 against which die centering nut 406 may apply force. In the preferred embodiment, orifice 402 is threaded and connector 403 comprises threads. As depicted in FIG. 5, flow sleeve 7 includes a plurality of passages 404 for melt stream 301 which communicate with the interior of flow sleeve 7. Die holder 8, depicted in FIG. 6, includes passages 405 which communicate with passages 404 and is inserted into the interior of flow sleeve 7, as depicted in FIG. 7. Melt stream 301 is introduced to cross head cartridge 10 via ball valve 2, which attaches to cross head cartridge 10 at orifice 402, passes through passages 404 and 405, and is applied to the exterior of first tubing 27 at the extruder die 26.

Of critical importance for the application of melt stream 301 to first tubing 27 and for adhesion of melt stream 301 to first tubing 27 is the temperature of melt stream 301. If the temperature of melt stream 301 is not kept sufficiently high, particularly at point of entry into the ball valve 2, melt stream 301 will solidify and therefore prevent application of melt stream 301 to first tubing 27. Moreover such solidification of melt stream 301 requires complete disassembly of cross head 400 to remove solidified melt stream 301.

To avoid solidification of melt stream 301, the invention includes a heater band 3 about retaining nut 1, which transfers heat to retainer nut 1 and then to ball valve 2. Thus retainer nut 1 must have a heat transfer coefficient sufficient to permit heat to pass therethough and to transfer sufficient heat to maintain the liquid form of uncolored material 28 and colored material 30. To identify the permit regulation of the temperature transferred through retaining nut 1, at least one and preferably two thermocouple ports 201 are created in retaining nut 1. A thermocouple is inserted in each thermocouple port 201 to identify the temperature of retaining nut 1. A computer (not shown) or other regulating system identifies the temperature at thermocouple port 201 and adjusts the temperature output of heater 3 accordingly.

The terms and expressions which have been employed in the foregoing specification are used therein as terms of description and not of limitation, and there is no intention, in the use of such terms and expressions, of excluding equivalents of the features shown and described or portions thereof.

I claim:

1. Chemically-inert color-coded tubing for use in chemical analysis comprising:
a. a first tube constructed of a chemically-inert material;
i. said first tube having an inner diameter;
ii. said first tube being extruded;
b. a second tube constructed of said chemically-inert material;
i. said second tube extruded about said first tube while not reducing the inner diameter of said first tube;
ii. said second tube formed proximate in time to the extrusion of first tubing;
iii. said second tube formed of colored material;
iv. said color of said colored material associated with the inner diameter of said first tube.
